(19) United States
(12) Patent Application Publication
(10) Pub. No.: US 2009/0055540 A1
(43) Pub. Date: Feb. 26, 2009

(54) Methods and Systems for Multicast Control and Channel Switching for Streaming Media in an IMS Environment

(75) Inventors: George Foti, Dollard des Ormeaux (CA); Paul Higgs, Roswell, GA (US)

Correspondence Address: ERICSSON INC., 6300 LEGACY DRIVE, M/S EVR 1-C-11, PLANO, TX, 75024, US

(73) Assignee: TELEFONAKTIEBOLAGET LM ERICSSON (PUBL), Stockholm (SE)

(21) Appl. No.: 11/841,064

(22) Filed: Aug. 20, 2007

(51) Int. Cl. G06F 15/177

(52) U.S. Cl. 709/228

(57) ABSTRACT

Systems and methods according to the present invention address this need and others by reducing the delay in channel zapping for streaming media, e.g., Internet Protocol television (IPTV). This delay is reduced by performing channel zapping through an Internet Multimedia Subsystem (IMS) architecture using Session Initiation Protocol (SIP) signaling.

### TECHNICAL FIELD

The present invention relates generally to telecommunications systems and in particular to methods and systems for improving the efficiency of channel zapping in streaming media, e.g., Internet Protocol television (IPTV), through the use of Internet Multimedia Subsystem (IMS) architectures and related signaling.

### BACKGROUND

As the level of technology increases, the options for communications have become more varied. For example, in the last 30 years in the telecommunications industry, personal communications have evolved from a home having a single rotary dial telephone, to a home having multiple telephone, cable and/or fiber optic lines that accommodate both voice and data. Additionally cellular phones and Wi-Fi have added a mobile element to communications. Similarly, in the entertainment industry, 30 years ago there was only one format for television and this format was transmitted over the air and received via antennas located at homes. This has evolved into both different standards of picture quality such as, standard definition TV (SDTV), enhanced definition TV (EDTV) and high definition TV (HDTV), and more systems for delivery of these different television display formats such as cable and satellite. Additionally, services have grown to become overlapping between these two industries. As these systems continue to evolve in both industries, the service offerings will continue to merge and new services can be expected to be available for a consumer. Also these services will be based on the technical capability to process and output more information, for example as seen in the improvements in the picture quality of programs viewed on televisions, and therefore it is expected that service delivery requirements will continue to rely on more bandwidth being available throughout the network including the “last mile” to the end user.

Another related technology that impacts both the communications and entertainment industries is the Internet. The physical structure of the Internet and associated communication streams have also evolved to handle an increased flow of data. Servers have more memory than ever before, communications links exist that have a higher bandwidth than in the past, processors are faster and more capable and protocols exist to take advantage of these elements. As consumers' usage of the Internet grows, service companies have turned to the Internet (and other IP networks) as a mechanism for providing traditional services. These multimedia services include Internet Protocol television (IPTV, referring to systems or services that deliver television programs over a network using IP data packets), Internet radio, video on demand (VOD), voice over IP (VoIP), and other web related services received singly or bundled together.

Regarding IPTV, a simplified system for delivering IPTV channels to an end user is shown in FIG. 1. In FIG. 1, a TV 10 is connected to a set-top box (STB) 12. STB 12 is in communication with an Access Node 14 which in turn is connected with an IP Network 16. Access Node 14 represents any type of node which could be used to connect STB 12 to an IP Network 16 such as a Digital Subscriber Line Access Multiplexer (DSLAM). IP Network 16 is in communication with the IPTV Application Server (AS) 20 which provides services and applications that can be delivered to an end user, e.g., Internet Protocol Television (IPTV) services. IPTV AS 20 is in communication, as shown by the dashed line 24, with a media server 18 which contains media that an end user desires to view upon TV 10. Additionally, media server 18 delivers the IPTV channels containing streaming video in the desired format, e.g., Moving Pictures Expert Group (MPEG) 2 or MPEG-4, to an end user and displayed upon TV 10. Streaming media generally refers to multimedia that is continuously transmitted by a provider and received by an end user that can typically be displayed while being received by an end user. Examples of streaming media include television or radio as compared to non-streaming media such as a book or a video movie stored on and retrieved from a local media, e.g., a disk. Additionally, it will be understood that there could be more intervening nodes between the STB 12 and the IPTV AS 20 than those shown in the simplified system of FIG. 1.

Utilizing the system shown in FIG. 1, a call flow diagram for changing IPTV channels in a multicast environment is shown in FIG. 2. In this simplified example, the viewed IPTV channel is changed as a result of a series of messages that use Internet Group Management Protocol (IGMP). Initially, STB 12 is receiving channel 1 streaming video 110 from media server 18 which it buffers and decodes prior to forwarding the signal on to a television or other end user device (not shown). A user then informs the STB 12 of the desire to change channels, e.g., via a remote control device (not shown). This triggers the STB 12 to transmit an IGMP Leave message 112 to Access Node 14. Access Node 14 then optionally transmits an IGMP Query message 114 back to the STB 12. After a predetermined period, if Access Node 14 receives no contrary response to its optional IGMP Query Message 114, the Access Node 14 transmits the IGMP Leave message 116 through an IP network 16 to the Media Server 18. Upon receipt of the IGMP Leave message 116, media server 18 ceases streaming channel 1 toward the STB 12.

At some point in time after transmitting the IGMP Leave message 112, the STB 12 transmits an IGMP Join message 118 indicating the new channel of interest. Access Node 14 receives the IGMP Join message 118. If the Access Node 14 has the requested stream, the Access Node 14 replicates that stream to the STB 12. On the other hand, if the Access Node 14 does not have the requested stream, it forwards the IGMP Join message 120 upstream through IP Network 16 to the media server 18 which then commences streaming of channel 2 streaming video 122 towards the STB 12.

This process for channel changing in an IPTV system can introduce noticeable delays due to, for example, the use of IGMP signaling and the potentially long distances and multiple nodes involved through which the IGMP messages travel, in addition to the slow processing of the IGMP messages across all these nodes which have various degrees of processing capabilities. Additional delays visible to the user during channel changing stem from the need for the STB 12 to perform a significant amount of buffering and decoding of the video signals, which is not always practical and potentially very slow. It would not be uncommon for the delay in channel changing (also known as channel zapping) to be between 2-7 seconds.

To accommodate the new and different ways in which IP networks are being used to provide various services, such as IPTV, new network architectures are being developed and standardized. One such development is the Internet Protocol Multimedia Subsystem (IMS). IMS is an architectural framework for delivering IP multimedia services to an end user. IMS architecture has evolved into a service-independent topology which uses IP protocols, e.g., Session Initiation Protocol (SIP) signaling to provide a convergence mechanism for disparate systems. In part this is accomplished via the provision of a horizontal control layer which isolates the access network from the service layer. More details regarding IMS architectures are provided below. Among other things, IMS architectures may provide a useful platform for the rollout of IPTV systems and services.

Accordingly exemplary embodiments described below address the need of improving the efficiency of channel zapping in streaming media systems, such as IPTV, through the use of IMS architectures and related signaling.

### SUMMARY

Systems and methods according to the present invention address this need and others by improving the efficiency of channel zapping in streaming media systems, such as IPTV, through the use of IMS architectures and related signaling.

According to one exemplary embodiment a method for changing streaming media channels including: receiving streaming media channels and buffering data associated with each of the streaming media channels; transmitting a first streaming media channel toward a client device; receiving a Session Initiation Protocol (SIP) message with information associated with a change in streaming media channels from the first streaming media channel to a second streaming media channel; ceasing transmission of the first streaming media channel; commencing transmission of the second streaming media channel toward the client device; and transmitting a SIP message indicating successful changing of the streaming media channels.

According to another exemplary embodiment a communications node including: a first processor in communications with a memory unit for receiving streaming media channels and buffering data associated with each of the streaming media channels, wherein the first processor transmits a first streaming media channel toward a client device; and a second processor for transmitting and receiving Session Initiation Protocol (SIP) messages including information associated with a change in the streaming media channels, wherein the second processor transmits a first message to the first processor to cease transmission of the first streaming media channel and transmits a second message to the first processor to transmit a second streaming media channel toward the client device.

### BRIEF DESCRIPTION OF THE DRAWINGS

The accompanying drawings illustrate exemplary embodiments, wherein:

FIG. 1 depicts a conventional system for receiving Internet Protocol television (IPTV) channels;

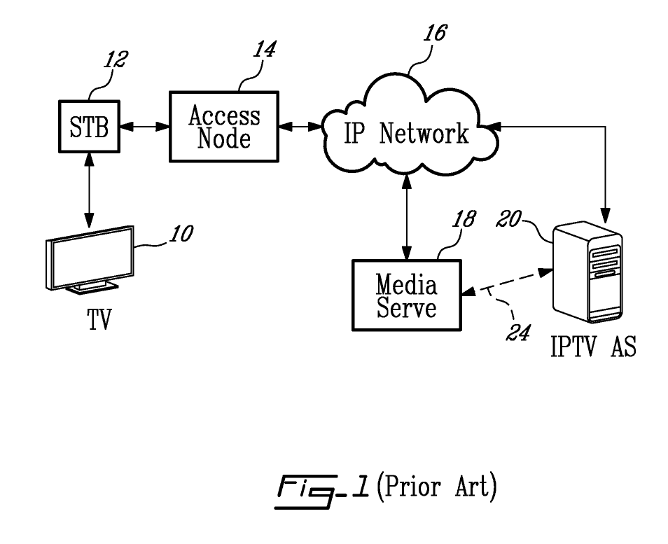

FIG. 2 depicts a conventional call flow diagram using Internet Group Management Protocol (IGMP) for channel zapping in an IPTV environment;

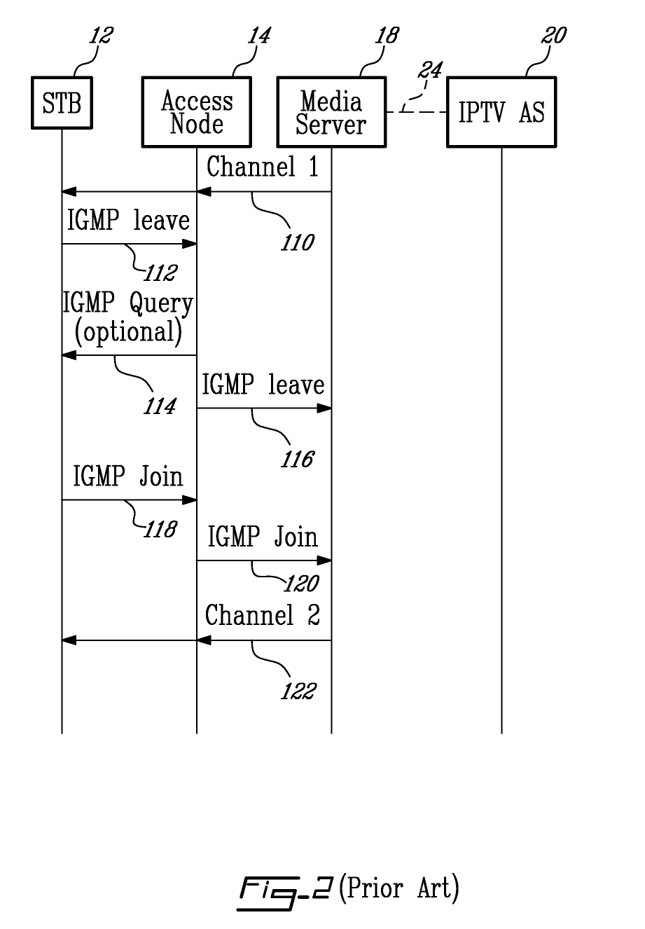

FIG. 3 illustrates an Internet Protocol Multimedia Subsystem (IMS) architecture and the associated control plane and media plane signaling according to exemplary embodiments;

FIG. 4 shows a call flow diagram for establishing an IMS channel according to exemplary embodiments;

FIG. 5 depicts a call flow diagram for channel zapping according to exemplary embodiments;

FIG. 6 depicts a communications node according to exemplary embodiments;

FIG. 7 shows a flowchart for changing streaming media channels according to exemplary embodiments; and

FIG. 8 is a flowchart illustrating a technique for synchronizing data packets associated with a newly selected channel according to an exemplary embodiment.

### DETAILED DESCRIPTION

The following detailed description of the exemplary embodiments refers to the accompanying drawings. The same reference numbers in different drawings identify the same or similar elements. Also, the following detailed description does not limit the invention. Instead, the scope of the invention is defined by the appended claims.

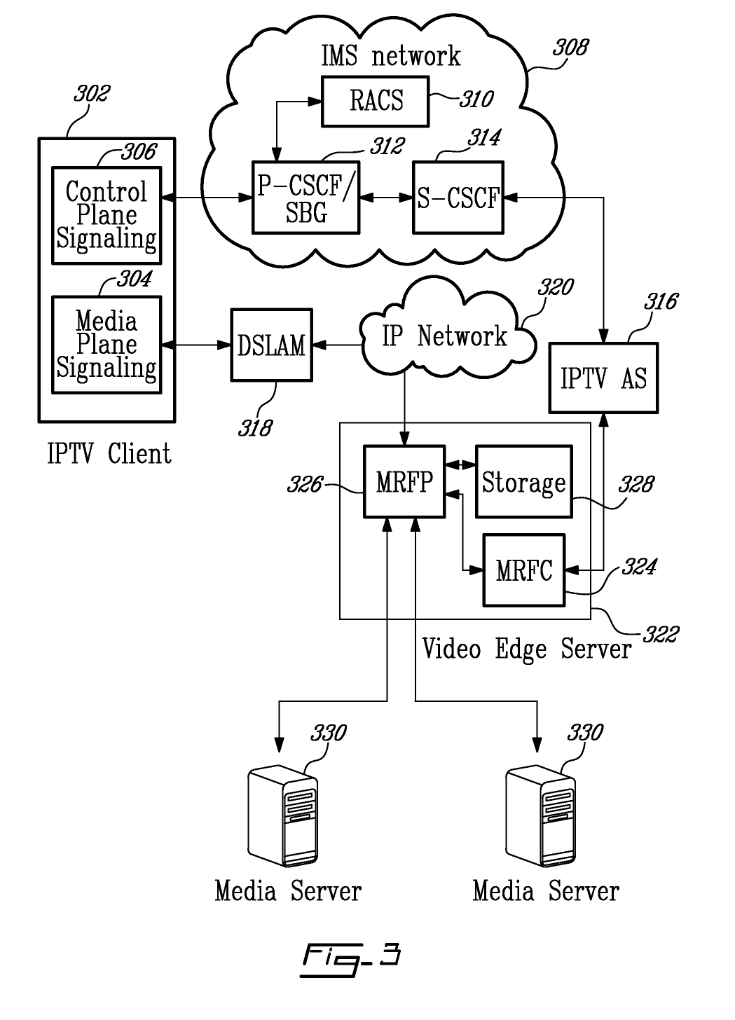

As described above, considerable delay may exist when using Internet Group Management Protocol (IGMP) signaling for channel zapping in streaming media, e.g., Internet Protocol television (IPTV). According to exemplary embodiments, this delay can be reduced when performing channel zapping for IPTV by using Internet Multimedia Subsystems (IMS) architectures and corresponding Session Initiation Protocol (SIP) signaling. An exemplary IMS architecture for IPTV, and more particularly channel zapping for IPTV or other streaming media, according to exemplary embodiments is described below with respect to FIG. 3.

Therein, an end user has a device that acts as an IPTV Client 302, e.g. a set-top box in communication with a TV which is identified with an end user, which has a Control Plane Signaling function or component 306 and a Media Plane Signaling function or component 304. Regarding the communication flow in the control plane, the Control Plane Signaling component 306 of the IPTV Client 302 is in communications with a Proxy-Call Session Control Function (P-CSCF)/Session Border Gateway (SBG) 312 in an IMS network 308. The P-CSCF 312 acts as both a SIP proxy and as the first point of contact in the IMS network 308 for the IPTV Client 302. The P-CSCF 312 is also in communications with other nodes within the IMS network 308 such as the Resource Admission and Control subsystem (RACS) 310, which deals with delivering policy based transport control services, e.g., resource reservation, at a certain time for a specific application, and a Serving-Call Session Control Function (S-CSCF) 314, which is a SIP server that provides session control. Based upon received signals, the S-CSCF 314 determines which application server to communicate with to provide a requested service, in this case IPTV AS 316.

IPTV AS 316 is also in communications with a Video Edge Server 322 according to this exemplary embodiment. Video Edge Server 322 includes a Multimedia Resource Control Function (MRCF) 324, a Multimedia Resource Function Processor (MRFP) 326 and memory storage unit 328. The MRCF 324 is also considered to be within the signaling plane and receives IMS signaling inputs from the IPTV AS 316 to control the MRFP 326, which is a media plane node that receives and transmits streaming media. The memory storage unit 328 is used, for example, to buffer critical information from streaming media as will be described below. Communicating in the media plane, the MRFP 326 receives video inputs relating to, e.g., IPTV channels, from media server(s) 330. Streaming media is then transmitted from the MRFP 326 through an IP network 320 to a node such as Digital Subscriber Line Access Multiplexer (DSLAM) 318, which forwards the media to the Media Plane Signaling component 304 of the IPTV Client 302.

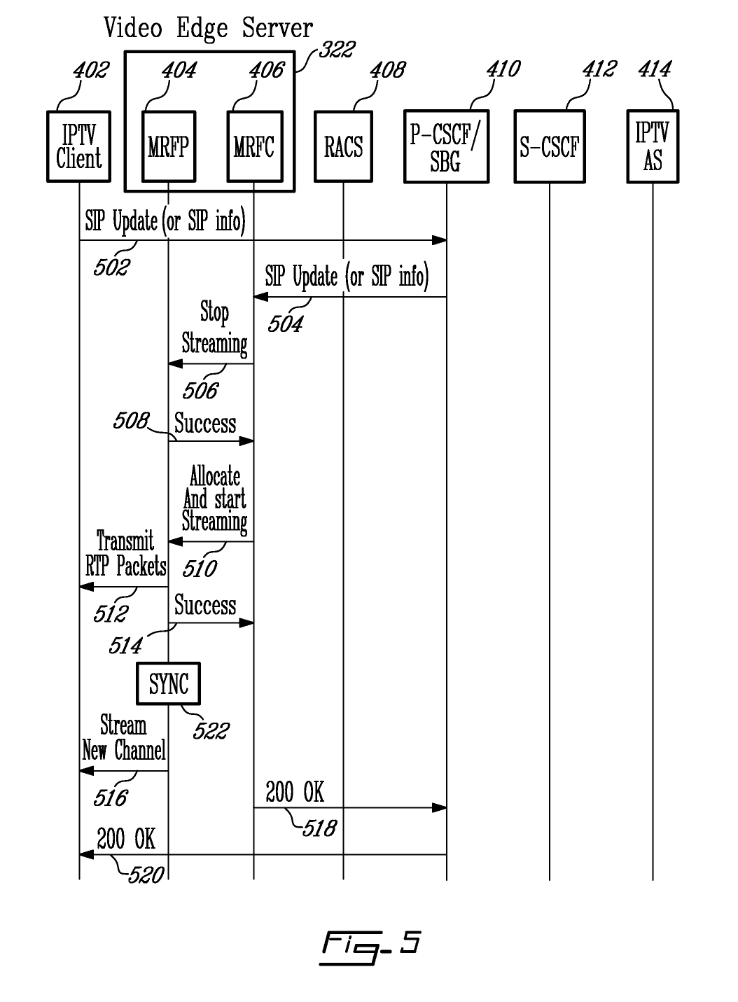

As mentioned above, the Video Edge Server 322 interacts in both the signaling plane and the media plane. The MRFC 324 receives SIP signaling in the control plane regarding IPTV channel information, or other streaming media channel information, from the IPTV AS 316, or from the IPTV client 302. The MRFC 324 processes these instructions and transmits instructions of its own using, e.g., H.248 protocol, to the MRFP 326 for implementation. An example of this control signaling will be described below with reference to FIG. 5. Additionally, the MRFC 324 is responsible for controlling all of the video stream resources in the MFRP 326. The MFRP 326 receives instructions from the MFRC 324 and is responsible for providing resources, mixing incoming media streams if necessary, replicating media streams, and processing media streams as necessary.

Additionally, according to exemplary embodiments, the memory storage unit 328 (or the memory within the MRFP 326) is capable of storing, for example, between 1.5-2 seconds worth of streaming video for all received multicast IPTV channels that a user could have access to in, for example, either Moving Pictures Expert Group (MPEG)-2 or MPEG-4 format. The specific amount of video to be stored for all IPTV channels can be selected according to exemplary embodiments to ensure that a complete information frame or intraframe (I-frame) is captured in either memory storage unit 328 or the memory within the MRFP 326 at any time plus the subsequent frames until the next I-frame where the memory storage can be refreshed and the storage cycle is repeated. The stored information may, therefore, be more or less than sufficient packets to enable between 1.5-2 seconds of displayed video. This storage of video data allows a reduction in the time noticed by an end user when channel zapping in IPTV, e.g., by permitting the MRFP 326 to rapidly transmit video data associated the newly selected channel upon receipt of a channel switching command from the MRFC 324. The manner in which this stored video is transmitted will be described in more detail below.

Regarding I-frames, streaming video using either the MPEG-2 or MPEG-4 format includes I-frames, predicted frames (P-frames) and bi-predictive frames (B-frames). I-frames are coded with references to only themselves and can allow a device to decode the I-frame to start a picture from scratch at the point represented by the I-frame. P-frames reference other previous pictures for decoding purposes and cannot be used by themselves to begin a new video stream, while B-frames can use both a past and a subsequent frame to reconstruct their output. These frames are sent in various sequences designated as Groups of Pictures (GOPs). An example of a sequence of I-frames, P-frames and B-frames used in video is I-B-B-P-B-B-P-B-B-P-B-B-P-B-B-I, which has a repeat interval of fifteen for the I-frames. In other words, each sixteenth frame received is a new and complete I-frame. This is relevant to channel zapping in IPTV systems because the new channel desired to be viewed by an end user cannot be streamed until an I-frame is received by the MRFP 326. According to exemplary embodiments either the MRFP 326 or the associated memory storage unit 328 can include sufficient memory to contain the entire repeat interval for an I-frame in all received streamed video from a media server(s) 330. This reduces the delay in channel zapping because there is no need to wait for a new I-frame to be received by either the MRFP 326 or the memory storage unit 328 to commence streaming of the new channel to an end user since a current I-frame is readily available in local memory for transmission.

However, providing the MRFC 324/MRFP 326 with this capability, and thereby reducing channel zapping delay perceived by the end user, generates a corresponding synchronization issue. For example, the data packets which are initially received by the end user/client device and used to display the new IPTV channel will initially be out of synchronization with the data packets being transmitted by the media server 330 and forwarded (e.g., via replication at the MRFP 324) to other end users/client devices who are already watching that channel. This lack of synchronization is due to the time lapse associated with pre-storing a certain amount of video data for that channel and subsequently transmitting the pre-stored data as an individual stream toward the end user/client device that has requested the channel change. To address this synchronization issue, the MRFP 326 is, according to these exemplary embodiments, provided with the additional capability (including associated hardware and software) to initially transmit, via real time protocol (RTP), packets of video for the new channel to the IPTV Client 302 at a transmission speed which is higher than that associated with the ongoing multicast replication of the new IPTV channel for other users currently watching that channel. More specifically, the hardware includes a clock(s) that runs faster than the clock used in transmitting the RTP packets used for normal replication of an IPTV channel. The clock speed for this unicast transmission needs to be sufficient to ensure that synchronization will happen with the next I-frame, i.e., to not exceed one I-frame cycle. Additionally, the hardware includes logic used to compare the individual unicast stream and the replicated stream which allows the system to detect when synchronization occurs. Software can be used by the system to instruct the MRFP 326 to replicate the stream to the IPTV Client 302, while ceasing the “faster” unicast stream to the IPTV Client 302 once synchronization of the I-frames is detected. Additionally, the MRFP 326 is able to handle synchronization of unicast streams for multiple clients desiring to watch that same channel, which typically requires the MRFP 326 to have a baseline stream for any stream that it might have to replicate even if no viewers are currently watching that channel.

Thus the video is transmitted via RTP packets until the MRFP 326 receives a new I-frame from media server 322 with which it can synchronize, allowing the IPTV Client 302 to receive the multicast stream in the same manner as any other end user watching that same channel.

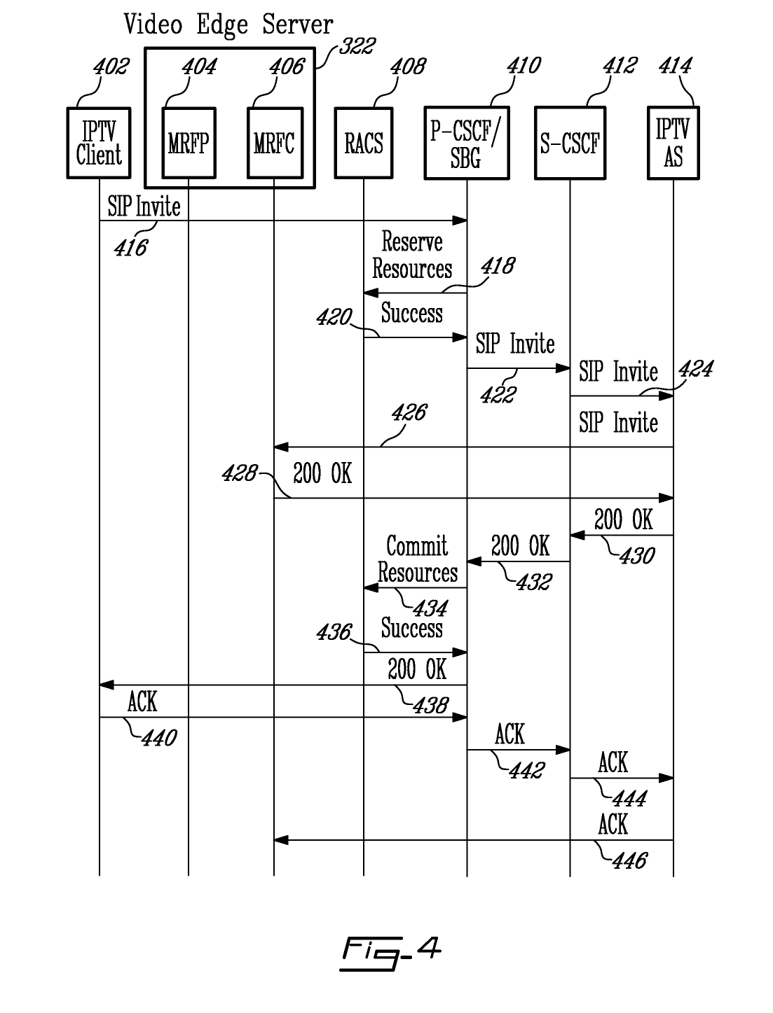

Using the above described exemplary architecture described in FIG. 3, an exemplary call flow for SIP controlled media streaming via Video Edge Server 322 will now be described with respect to the exemplary embodiment of FIG. 4. Initially, an IPTV Client 402 transmits a SIP INVITE message 416 for session setup to the P-CSCF/SBG 410. The P-CSCF/SBG 410 transmits a message 418 for reserving resources to the RACS 408. Upon completion of the request, the RACS 408 transmits a Success message 420 indicating successful reservation of resources back to the P-CSCF/SBG 410. The P-CSCF 410 transmits SIP INVITE message 422 to the S-CSCF 412 which then sends a SIP INVITE message 424 to the appropriate IPTV AS 414. The IPTV AS 414 then sends a SIP INVITE message 426 to MRFC 406 which resides within Video Edge Server 322. The MRFC 406 responds with a 200 OK message 428 indicating that the request was successful to the IPTV AS 414. The IPTV AS 414 then transmits a 200 OK message 430 to the S-CSCF 412 which transmits a 200 OK message 432 to the P-CSCF/SBG 410.

The P-CSCF/SBG 410 instructs the RACS 408 to commit the desired resources in message 434. Upon the commitment of resources, the RACS 408 transmits a Success message 436 back to the P-CSCF/SBG 410. The P-CSCF/SBG 410 then transmits a 200 OK message 438 to IPTV Client 402 which responds with an acknowledgement message 440 acknowledging success to the P-CSCF/SBG 410. The P-CSCF/SBG 410, in turn, forwards an acknowledgement message 442 to the S-CSCF 412 which indicates that node's receipt of message 440. Also at this time, a state for that session is established in, for example, all nodes that remain in the signaling path for subsequent signaling for the IPTV Client 402 for the powered up STB associated with the IPTV Client 402 which includes the IP address to which future data is to be streamed. The S-CSCF 412 then transmits acknowledgement message 444 to the IPTV AS 414, which then transmits an acknowledgement message back to the MRFC 406 inside the video server 322 to complete the process. Media, e.g., a first IPTV channel which provides streaming audio and video, can then be supplied to the IPTV client 402. Additionally, it will be understood that prior to performing the IMS signaling shown in FIG. 4, a power up sequence including successful access/authorization for an IMS user to the IMS network will typically have already been completed.

According to exemplary embodiments, during the above-described exemplary procedure, a number of other aspects of SIP controlled media streaming are established. For example, a Quality of Service (QoS) associated with the service to be provided to the end user is established and transmitted to the relevant nodes. Additionally, the IPTV AS 414 allocates a Video Edge Server 322 for transmitting IPTV channels which is located as close as possible to the end user's geographical location. Moreover, according to some exemplary embodiments, neither the S-CSCF 412 nor the IPTV-AS 414 Record-Route themselves in a SIP header in the signaling path which permits future communications utilizing SIP signaling to go directly between the TPTV Client 402 and the Video Edge Server 322 via the P-CSCF/SBG 410. These features shorten the travel path of future signaling communications, which in turn reduces the delay seen by the end user when interacting with the system to perform various activities such as channel zapping.

After an end user has completed the above described exemplary procedure for establishing IMS/SIP controlled streaming media, the end user has the ability to change IPTV channels. An exemplary call flow for channel zapping in IPTV which use SIP signaling will now be described with respect to the exemplary embodiment of FIG. 5. When an end user is watching an IPTV channel and wishes to change channels, he or she informs the IPTV Client 402 of the desire to switch to a new IPTV channel through any of a number of methods such as, for example, a remote control device in communication with a STB. The IPTV Client 402 transmits a SIP UPDATE (or SIP INFO) message 502 which includes an identifier associated with the new, desired channel for viewing to the P-CSCF/SBG 410. The P-CSCF/SBG 410 transmits a SIP UPDATE (or SIP INFO) message 504 which includes an identifier associated with the new, desired channel for viewing to the MRFC 406. The MRFC 406 is associated with a Video Edge Server 322 that is geographically close to the end user, and transmits a message 506 with instructions to stop streaming the current IPTV channel to the MRFP 404 associated with the same Video Edge Server 322.

The MRFP 404 ceases streaming of the current IPTV channel and informs the MRFC 406 of this in Success message 508. The MRFC 406 sends another message 510 to the MRFP 404 which includes instructions for allocating the required resources for the new channel indicated in the SIP signaling and to start streaming the new IPTV channel. The MRFP 404 then begins transmitting RTP packets 512, as described above, which are associated with the new IPTV channel to the IPTV Client 402 beginning with the first I-frame for the new IPTV channel. This first I-frame can be retrieved either from the MRFP's 404 local memory or from another memory storage unit 328 to reduce delay time as discussed above. As mentioned above, the RTP packets 512 can be transmitted more quickly than the packets received from the media server 330 for this channel in order to “catch up” to the current point in the video stream at which the rest of the multicast viewers are currently viewing the new IPTV channel. Upon achieving synchronization of the video at the MRFP 404, as shown by Sync box 522, the MRFP 404 ceases transmitting the RTP packets and streams the new channel 516 to the IPTV Client. In other words, the IPTV Client 402 is receiving the new channel at the same time as the other end users viewing this channel.

Success message 514 is transmitted back to the MRFC 406, which in turn transmits a 200 OK message 518 indicating that the request for changing channels was successful to the P-CSCF/SBG 410. The P-CSCF/SBG 410 then sends a 200 OK message to the IPTV Client 402 to complete this process. The exemplary embodiment of FIG. 5 also shows an S-CSCF 412 and an IPTV AS 414, which nodes are shown for continuity purposes albeit they are not involved in the exemplary channel zapping signaling shown in the Figure. Once the IMS control path is established, neither the S-CSCF 412 nor the IPTV AS 414 are required for channel zapping to occur and, by removing those nodes from the communication path, efficiency of channel zapping is further improved. The option for these nodes, i.e., S-CSCF 412 and IPTV AS 414, to be maintained in or removed from the signaling path can, for example, be based on policy and/or on subscriber profile information. For example, some services that may be invoked by the subscriber may require these nodes to remain in the signaling path. The presence of these nodes in the path constitutes minimum overhead since these nodes perform a proxy role during channel zapping and as such very little processing is required from them.

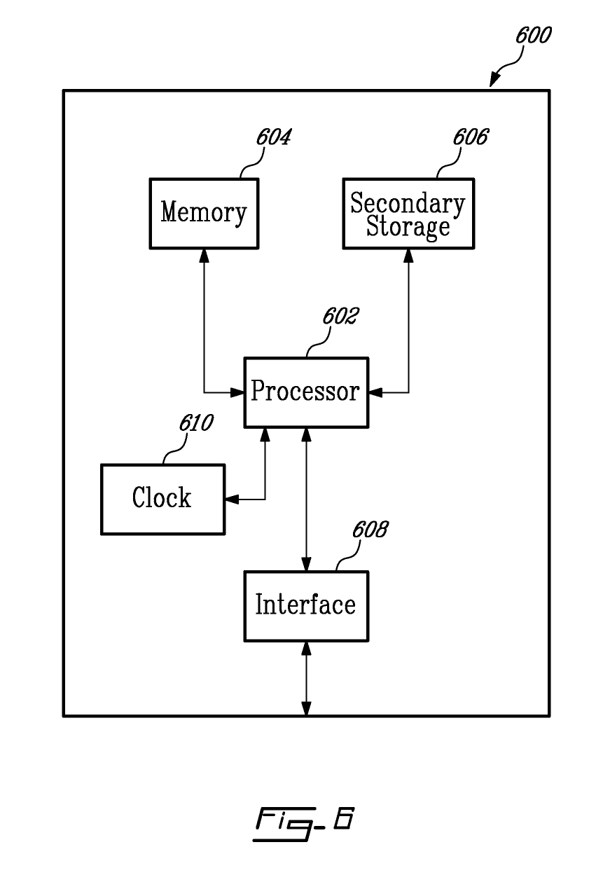

The exemplary embodiments described above provide for IPTV channel zapping involving media communications and nodes associated with an IMS architecture. An exemplary server 600 which can be used, for example, to implement Video Edge Server 322 described above, will now be described with respect to FIG. 6. Server 600 (or node) can contain a processor 602 (or multiple processor cores), memory 604, one or more secondary storage devices 606, a clock 610 (or multiple clocks, e.g., one associated with “faster” RTP transmissions and one associated with “normal” speed replication post synchronization as described above) and an interface unit 608 to facilitate communications between network node 600 and the rest of the network. Additionally, the server 600 can contain protocols allowing control plane communications to communicate with the media plane to ensure that the proper hardware (and/or software) is used for video streaming. Alternatively, the server 600 can receive instructions for media streaming and stream media in the media plane. In this case, when channel zapping occurs, the server 600 is capable of transmitting RTP packets in a unicast fashion to a new user viewing a new channel until synchronization of I-frames associated with the new channel occurs, whereupon an IPTV Client 402 receives the video as part of a normal multicast. The memory 604 (or the secondary storage 608) can be used for storage of exemplary data such as one complete I-frame cycle of video for all received IPTV channels. Alternatively, the server 600 can be in communications with a separate memory storage unit 328 which is capable of storing one complete I-frame cycle of video for all received IPTV channels. Thus, a network node according to an exemplary embodiment may include a processor(s) for transmitting and receiving messages associated with IPTV channel zapping.

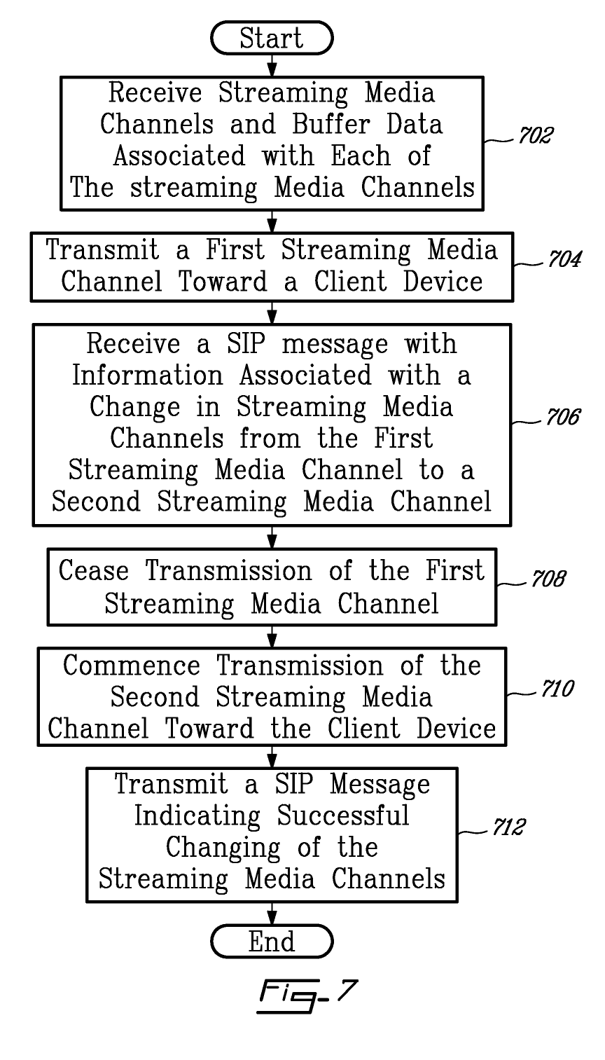

Utilizing the above-described exemplary systems according to exemplary embodiments, a method for changing streaming media channels is shown in the flowchart of FIG. 7. Initially a communications node receives streaming media channels and buffers data associated with each of the streaming media channels in step 702. The communications node then transmits a first streaming media channel toward a client device in step 704. The communications node then receives a SIP message with information associated with a change in streaming media channels from the first streaming media channel to a second streaming media channel in step 706. Upon receipt of the SIP message, the communication node ceases transmission of the first streaming media channel in step 708 and commences transmission of the second streaming media channel toward the client device in step 710. The communication node then transmits a SIP message indicating successful changing of the streaming media channels in step 712.

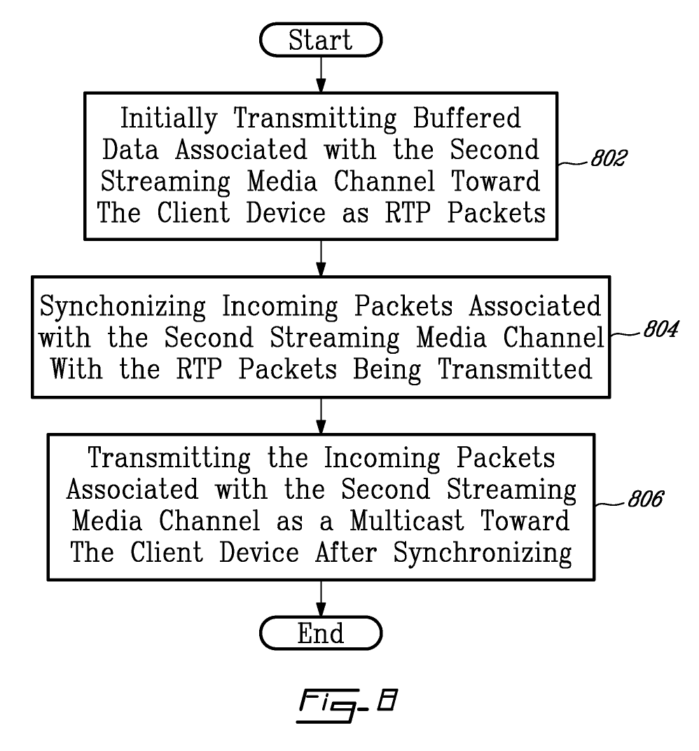

As mentioned above, synchronization can be performed to handle delay issues associated with changing channels using buffered and live data as shown in FIG. 8. Therein, at step 802, buffered data is initially transmitted toward the client device as RTP packets. While this is occurring, incoming packets for the newly selected second streaming media channel are synchronized with the RTP packets being transmitted at step 804. After synchronization, the incoming packets can be transmitted toward the client device instead of the RTP packets at step 806.

The above-described exemplary embodiments are intended to be illustrative in all respects, rather than restrictive, of the present invention. All such variations and modifications are considered to be within the scope and spirit of the present invention as defined by the following claims. No element, act, or instruction used in the description of the present application should be construed as critical or essential to the invention unless explicitly described as such. Also, as used herein, the article “a” is intended to include one or more items.

What is claimed is:

1. A method for changing streaming media channels comprising:
receiving streaming media channels and buffering data associated with each of said streaming media channels;
transmitting a first streaming media channel toward a client device;
receiving a Session Initiation Protocol (SIP) message with information associated with a change in streaming media channels from said first streaming media channel to a second streaming media channel;
ceasing transmission of said first streaming media channel;
commencing transmission of said second streaming media channel toward said client device; and
transmitting a SIP message indicating successful changing of said streaming media channels.

2. The method of claim 1, wherein said step of commencing transmission of said second streaming media channel toward said client device further comprises:
initially transmitting said buffered data associated with said second streaming media channel toward said client device as real time protocol (RTP) packets.

3. The method of claim 2, further comprising:
synchronizing incoming packets associated with said second streaming media channel with said RTP packets associated with said second streaming media channel that are being transmitted; and
transmitting said incoming packets associated with said second streaming media channel as a multicast toward said client device instead of said RTP packets after said synchronizing.

4. The method of claim 1, wherein said buffered data associated with each of said streaming media channels includes a complete information frame (I-frame) cycle of video.

5. The method of claim 4, further comprising:
retrieving an I-frame for said second streaming media channel.

6. The method of claim 5, wherein said step of commencing transmission of said second streaming media channel begins with said retrieved I-frame.

7. The method of claim 1, wherein said streaming media channels are Internet Protocol television (IPTV) channels.

8. The method of claim 6, wherein said streaming media uses at least one of Multimedia Pictures Expert Group (MPEG)-2 format and MPEG-4 format.

9. The method of claim 1, wherein said received SIP message is a SIP UPDATE message.

10. The method of claim 1, wherein said transmitted SIP message is a 200 OK message.

11. The method of claim 1, wherein said method for changing streaming media channels is performed by a video edge server.

12. The method of claim 11, wherein said video edge server includes:
a Multimedia Resource Function Processor (MRFP) for receiving streaming media channels and buffering data associated with each of said streaming media channels; and
a Multimedia Resource Control Function (MRCF) for transmitting and receiving SIP messages including information associated with a change in said streaming media channels.

13. The method of claim 1, wherein said client device is associated with an Internet Multimedia Subsystem (IMS) user.

14. A communications node comprising:
a first processor in communications with a memory unit for receiving streaming media channels and buffering data associated with each of said streaming media channels, wherein said first processor transmits a first streaming media channel toward a client device; and
a second processor for transmitting and receiving Session Initiation Protocol (SIP) messages including information associated with a change in said streaming media channels, wherein said second processor transmits a first message to said first processor to cease transmission of said first streaming media channel and transmits a second message to said first processor to transmit a second streaming media channel toward said client device.

15. The communications node of claim 14, wherein said first processor initially transmits real time protocol (RTP) packets of buffered data associated with said second streaming media channel toward said client device.

16. The communication node of claim 15, wherein said first processor synchronizes incoming packets associated with said second streaming media channel with said RTP packets associated with said second streaming media channel that are being transmitted, and Subsequently transmits said incoming packets associated with said second streaming media channel as a multicast toward said client device instead of said RTP packets.

17. The communications node of claim 14, wherein said first processor ceases transmission of said first streaming media channel upon receipt of said first message from said second processor and transmits said second streaming media channel upon receipt of said second message from said second processor.

18. The communications node of claim 17, wherein said first message is a non-SIP message and said second message is a non-SIP message.

19. The communications node of claim 18, wherein said non-SIP message is a H.248 message.

20. The communications node of claim 14, wherein said communications node is video edger server.

21. The communications node of claim 14, wherein said first processor is a Multimedia Resource Function Processor (MRFP) and said second processor is a Multimedia Resource Control Function (MRCF).

22. The communications node of claim 21, wherein said memory resides within either said MRFP or a memory storage unit within said video edge server.

23. The communications node of claim 14, wherein said data associated with each of said streaming media channels includes a complete information frame (I-frame) cycle of video.

24. The communications node of claim 23, wherein said I-frame is retrieved for said second streaming media channel.

25. The communications node of claim 24, wherein said step of commencing transmission of said second streaming media channel begins with said retrieved I-frame.

26. The communications node of claim 14, wherein said streaming media channels are Internet Protocol television (IPTV) channels.

27. The communications node of claim 14, wherein said streaming media uses at least one of Multimedia Pictures Expert Group (MPEG)-2 format and MPEG-4 format.

28. The communications node of claim 14, wherein a received SIP message is a SIP UPDATE message.

29. The communications node of claim 14, wherein a transmitted SIP message is a 200 OK message.

30. The communications node of claim 14, wherein said client device is associated with an Internet Multimedia Subsystem (IMS) user.
